(19) United States
(12) Patent Application Publication
(10) Pub. No.: US 2021/0245999 A1
(43) Pub. Date: Aug. 12, 2021

(54) Shipping Containers

(71) Applicant: BLOK CONTAINER SYSTEMS LIMITED, Warwick (GB)

(72) Inventor: Martin Clive-Smith, Warwickshire (GB)

(21) Appl. No.: 17/052,547

(22) PCT Filed: May 8, 2019
(86) PCT No.: PCT/GB2019/000067

§ 371 Date: Nov. 3, 2020

(30) Foreign Application Priority Data
May 9, 2018 (GB) 1807575.4
Feb. 13, 2019 (GB) 1902005.6

(51) Int. Cl. B66C 1/10; B65D 90/00

(52) U.S. Cl. CPC B66C 1/101; B65D 2590/0033; B65D 90/0013

(57) ABSTRACT

A method of testing a shipping container (10) for use as an upper container in a vertical tandem lift configuration the method comprising supporting the container other than by the lower corner fittings (15), connecting couplers (18) in the lower corner fittings of the container to be tested and then applying a proof load on the couplers to confirm that the container and/or the couplers can sustain the forces at least through the lower corner fittings which will be experienced during use in a vertical tandem lift. The invention also provides a rig (70, 143) for carrying out the proof test and/or for connecting or disconnecting couplers to or from the lower corner fittings of a shipping container. Various corner units for use in such a rig are also disclosed.

In the field of shipping containers, containers are locked to the deck of a ship or other containers in a vertical stack or to rail wagons or road trailers through their corner fittings using inter box connectors (IBCs) also known as twistlocks. These IBCs are of the semi-automatic twistlock form (SATs), fully automatic twistlock form (‘FATs’) and other forms including locator cones. Examples of FATs are shown in DE102012201797 and US 20150203287. These FATs have a head to lock into the sockets in the underside of lower corner fittings of the container and when the containers are being lifted they have a hook shaped tail which project downwards out of the fittings to engage with a socket in the top side of a container corner fitting. The IBCs are not part of the container equipment often having different owners, so it is more or less the rule that the IBCs are removed from the containers before they are moved on.

To remove the IBCs men conventionally step forward under the handling machine or crane and remove them by hand. Whilst complex sorting, fitting and removing twistlocking machines have been devised these are slow, expensive and unreliable with the process still requiring manual intervention. The machines are purpose built mostly needing a power source and not easily adapted to the varying locations and layouts of many existing ports. They must be placed under the ship to shore crane and thus take up the valuable quayside space further delaying the speed of processing containers. The variety of IBC designs also leads to complications and requires complex changes to machinery when different IBC designs are used. Time is of the essence in processing the container ships and the time taken to have the IBCs removed or fitted is critical to speedy efficient operations, regardless of safety issues. The known twistlocking machines have been designed to work with one container at a time and because the cycle time of the ship to shore crane is typically more than 90 seconds, the cycle time for the machine can be relaxed. However more and more cranes are now able to lift two or more containers at a time and this means that faster twistlocking machines are needed.

Known twistlocking machines are made as large single assemblies and are not easily adapted for variations in IBC designs, lengths of containers and are bulky to ship to their port of use and to move around at the port. Such known machines being heavily mechanised and of sophisticated operation, reliability is a concern and spare machines may be needed in case of break down that might delay the ship. In short they lack versatility. Examples of such known machines can be found in, for example, U.S. Pat. No. 8,562,265 and WO2011/096877.

25% of all containers around the world are moved empty. Some ports handle as many as 70% of empty containers. If empty containers were lifted in vertical tandem lift (VTL) whereby one container is stacked on top of another, connected to it via four inter box connectors of the SAT type, and the pair of containers lifted together as one with a lifting crane spreader connected only to the top of the upper container the advantage of this manoeuvre would be that a container ship could be loaded with empty containers twice as fast than if it were being loaded with containers one at a time.

VTL is allowed by regulation but this is being held back by concerns about the lifting strength of the upper container being able to lift the lower container through the bottom corner fittings of the upper container because containers in themselves were not designed specifically to be lifting devices. Containers are tested and certified to loads well in excess of the lifting load needed for VTL and experience loads well in excess of the lifting load needed when secured on board ship particularly when the ship is rolling and heaving in heavy seas.

Although containers are tested and certified to obtain design and structural type approval, they are not individually tested regularly as a crane or lifting device might be. A crane spreader would be tested to simulate 1.25 g acceleration every 2 years to certify its strength. Containers and IBCs are inspected visually and regularly but not proof tested as is a crane. Time taken for any task is always a problem for busy ports so it would be an advantage if the proof testing could be carried out very quickly immediately prior to shipping.

The present invention thus provides a method of testing a shipping container for use as an upper container in a vertical tandem lift configuration the method comprising supporting the container other than by the lower corner fittings, connecting couplers in the lower corner fittings of the container to be tested and then applying a proof load on the couplers to confirm that the container and/or the couplers can sustain the forces which will be experienced during use in a vertical tandem lift.

This proof testing of the container and couplers can be carried out rapidly within the supply chain of containers immediately before use to confirm that the container can be used in a vertical tandem lift configuration. Evidence that the containers and IBCs have been proof tested correctly is essential if all those in the supply chain from Nigeria to USA, Vladivostok to Rio are to have confidence in the system. The method of testing of the present invention provides this certainty that a pair of containers can be lifted in VTL connected by their IBCs.

In the above method the couplers in the lower corner fittings of the container may be inserted into respective corner units of a test rig, the rig and container being moved relative to each other to generate the proof load.

The rig and container may be moved relative to each other by lifting the container away from the test rig.

The rig and container may be moved relative to each other by applying mechanical/hydraulic force between the rig and the container. Alternatively, the rig may be moved relative to the container by loading the rig with a test force sufficient to apply the proof load and then lifting the container via its upper corner fittings.

The test force may be off set from the couplers to apply additional leveraged load on the couplers more than the value of the test force. The test force may be applied as a dead weight.

The rig may be held down and load cells fixed to a machine for lifting the container to measure the force on the couplers and lower fittings.

As part of the method, data regarding the test is recorded and stored for future reference and proof of the fitness of the container for use in a vertical tandem lift.

The recorded test data may include one or more of the following parameters namely date of the test, container number and its known statistics, test load, inspector identification, container and coupler condition and approval, the data so collected forming formal verification that the proof test and inspection has been carried out correctly.

The invention also provides a rig for carrying out the method of testing described above and/or for connecting or disconnecting couplers to or from the lower corner fittings of a shipping container, the rig comprising two pairs of corner units, the corner units of each respective pair being held in the required transverse spacial relationship with the lower corner fittings at each respective end of the container, the two pairs of corner units also being held in the required longitudinal spacial relationship relative to the corner fittings of the container so that all the corner fittings of the container can be worked on simultaneously. Each corner unit also preferably has an indexing means for rotating tail portions of any couplers inserted into the units.

The corner of each pair may be held in the required transverse spacial relationship with the lower corner fittings at each respective end of the container by a structure extending between the units of each pair to form separate end modules.

The rig may have a box for containing the dead weight sufficient to apply the proof load or for storing couplers or housing a prime mover of the rig is supported from the structure which extends between the two corner units or comprises the structure itself.

The two pairs of corner units may be to a common base member in the required longitudinal spacial relationship. This common base member may be a trailer having sockets and/or connectors built into its frame to secure the corner units in the required spacial relationship.

Alternatively, the two pairs of corner units may be held in the required longitudinal relationship by side rails which extend longitudinally between the pairs of corner units. These side rails or trailer arrangement may allow different longitudinal spacing of the two pairs of corner units to cater for containers of different lengths.

The rig may include more than one pair of corner units at each end of the rig, different pairs of corner units being used for different types of coupler or for carrying out different operations on couplers placed in the corner units.

The corner units of the rig may be positioned to accommodate containers of different lengths.

The rig may also be transportable to its port of use in sections for assembly at the port.

The invention further provides a corner unit for use in a rig as described above in which indexing means is provided for holding a semi-automatic twistlock (SAT) coupler inserted into the unit in at least one of its three positions namely head locked/tail locked, head locked/tail unlocked, and head unlocked/tail locked, the indexing means being manually moveable between these positions to allow proof testing of the container and/or coupler and/or also to allow connection or disconnection of couplers to or from the lower corner fittings of the container.

There is also provided a corner unit for use in a rig as described above in which bias means biases a lever against a stop to hold the tail of any coupler in the unit in an unlocked position with its head in a locked position, as the container is lowered onto the corner unit a plunger moves the stop to allow the bias means to rotate the indexing means to unlock the coupler from the overhead container and lock the coupler to the unit to allow the container to be lifted without the coupler.

In the above corner unit the indexing means can be rotated away from the stop initially against the bias means until the bias means goes over centre and begins to assist the further rotation of the indexing means away from the stop to lock the coupler to the unit and to the container to allow proof testing. The plunger can be deactivated to prevent locking of the coupler to the unit so that the container can be raised with the coupler attached to its lower corner fitting.

In a further form of corner unit for semi-automatic twistlocks (SATs) when a coupler is lowered into the unit on a container an actuating member of the SAT, which when pulled rotates its head and tail against internal torsional springing, engages an abutment on an end of a pivoted lever, the lever is arranged to be moved against bias means by a plunger which is moved by the tail of the coupler as it enters the unit, the plunger contacts the lever to move the lever against the bias means and thus pull the actuating member to rotate the head and tail of the coupler to the head unlocked/tail locked position allowing the container to be raised without the coupler.

In the above corner unit further movement of the plunger can be arranged to disengaged the cam means to allow the lever to be moved back by the bias so that the actuating member goes slack and the coupler rotates to its head locked/tail locked position thus locking the container to the unit.

In a corner unit for a fully automatic twistlock (FAT) and for use in a rig as described above an indexer is arranged to receive a FAT placed into the unit and bias means biases a lever against a stop to hold the head of the FAT in an unlocked position, as a container is lowered onto the corner unit a plunger moves the stop to allow the bias means to rotate the indexing means to lock the head of the FAT to the lowered container and to allow the container to be lifted with the coupler.

In such an arrangement the bias means can be reversed so that when a container with a FAT is lowered onto the unit, the indexer holds the FAT in the head locked position, as the container is lowered the plunger moves the stop to allow the bias to rotate the indexer to the head open position to allow the container to be lifted away without the coupler.

In an alternative corner unit arrangement for use in the above described rigs the indexing means may comprises one or more resiliently biased elements located under the top plate which when the tail of a SAT passes through the thickness of the top plate press on the sides of the tail and rotate the tail against its internal torsional springing to engage the tail under the top plate and put the head in the release position to allow the container to be lifted away without the coupler.

The invention also provides a corner unit for use in the above described rigs in which the unit is arranged to receive and support a SAT placed into the unit in a position where its toggle wire is accessible to an operator to allow the operator to move the SAT to all three of its positions namely head locked/tail locked, head locked/tail unlocked, and head unlocked/tail locked by use of the toggle wire.

Some of the above rig and corner unit arrangements can be used to both proof test the container and coupler and also connect and disconnect couplers from containers. Also the rig constructions described above are particularly economical to transport to their port of use as they can transported as pairs of corner units connected by their associated interconnecting structure or can be broken down further to their individual corner units with their separate associated interconnecting structure allowing several test rigs to be transported in a single shipping container.

The corner units described are also suitable for fitting and removing most types of SATs and FATs and should special features in the operation or shape of the SAT or FAT need to be accommodated the moving parts of the for corner units can quickly be exchanged for tailored mating parts.

The corner units can also be set up to use a plunger activated by movement of the container to trigger the corner unit to discharge the SATs and FATs into storage areas.

The present invention will now be described, by way of example, with reference to the accompanying drawings in which:

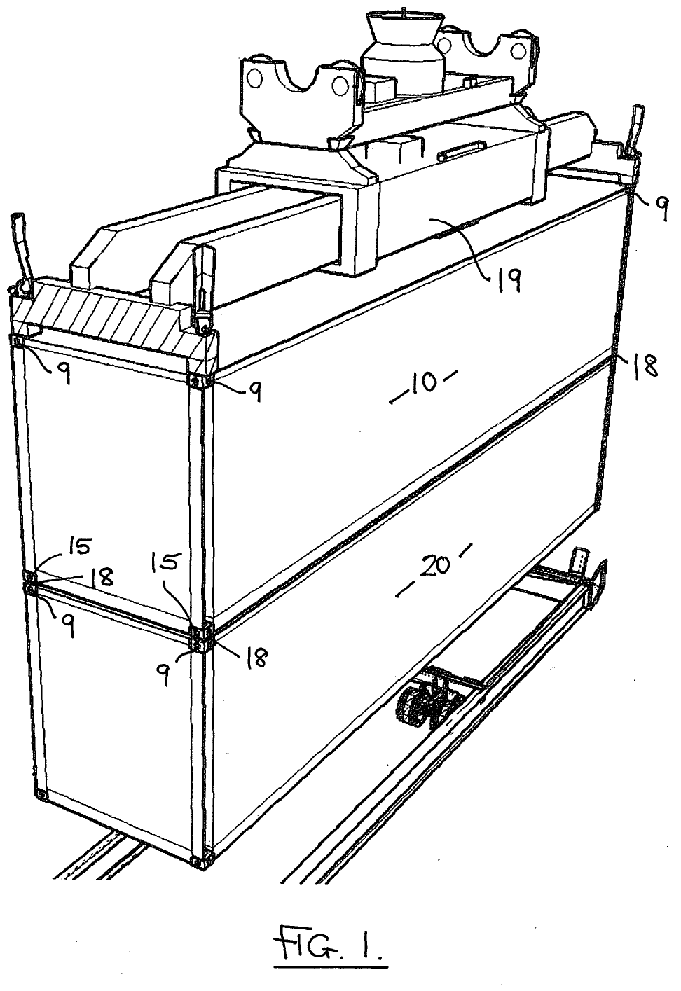

FIG. 1 is a perspective view of two containers being lifted in a vertical tandem lift configuration;

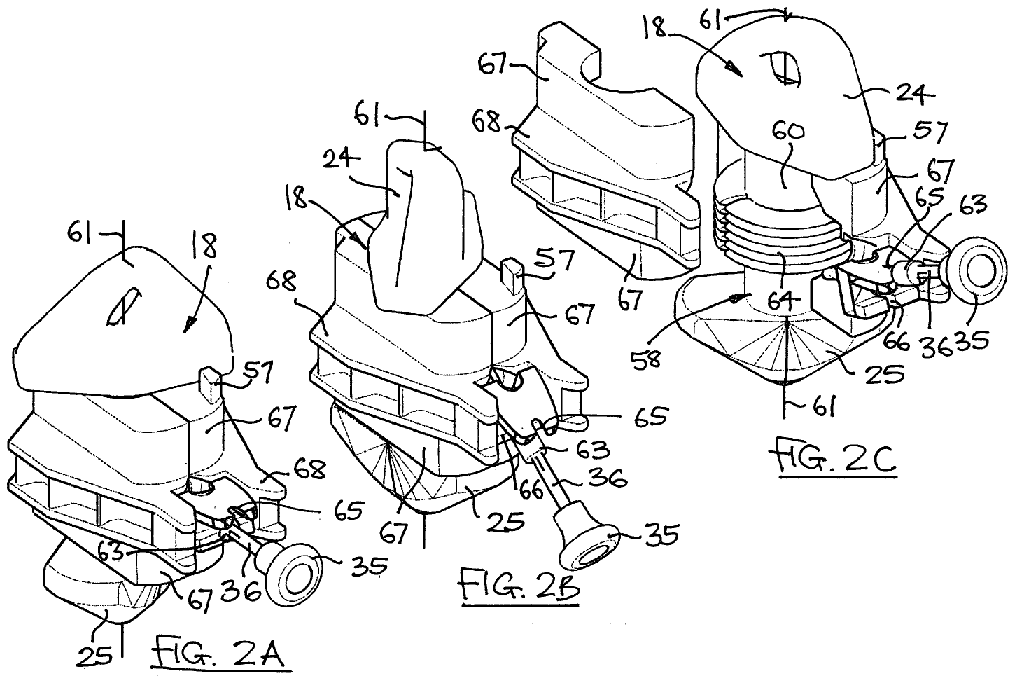

FIGS. 2A, 2B and 2C show a semi-automatic twistlock (SAT) in its three operating positions;

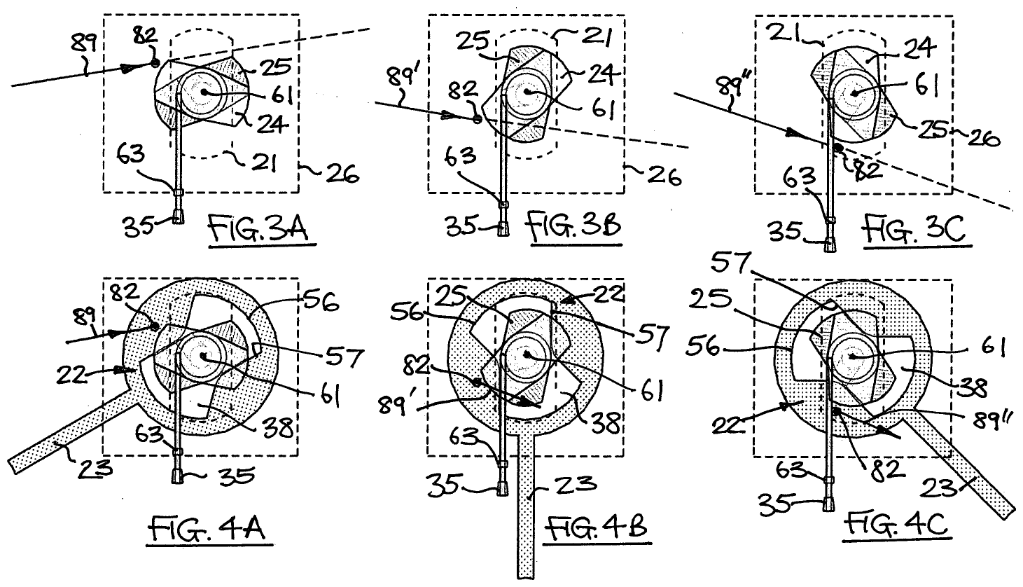

FIGS. 3A, 3B and 3C are diagrammatic plan views of the three operating positions of the SAT shown in FIGS. 2A, 2B and 2C showing the positions of the head and tail of the SAT and the over centre action of an actuating spring;

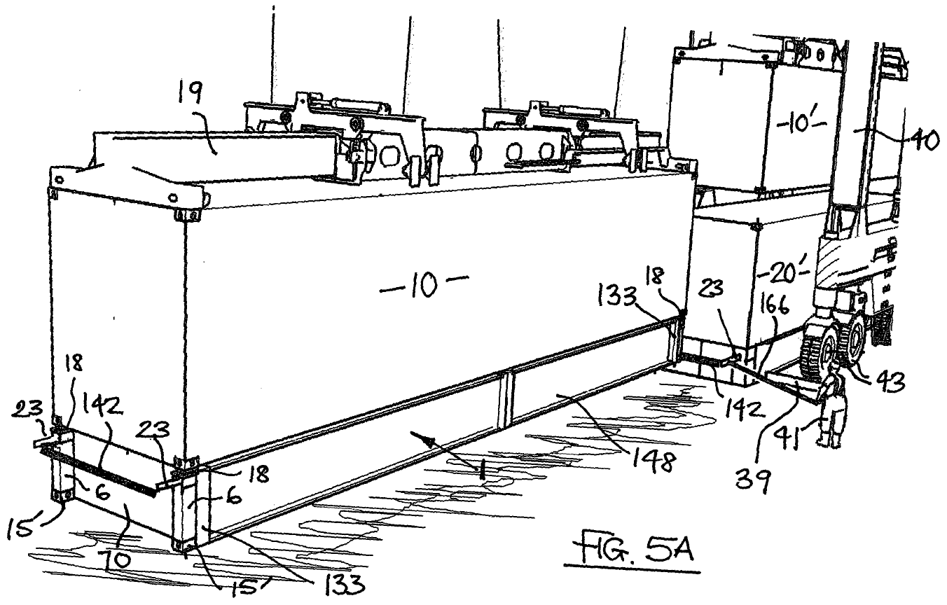

FIGS. 4A, 4B and 4C are diagrammatic plan views of the three operating positions of the SAT shown in FIGS. 2A, 2B and 2C showing the positions of the head and tail of the SAT and the positions of an operating lever and indexer used to rotate the tail of the SAT;

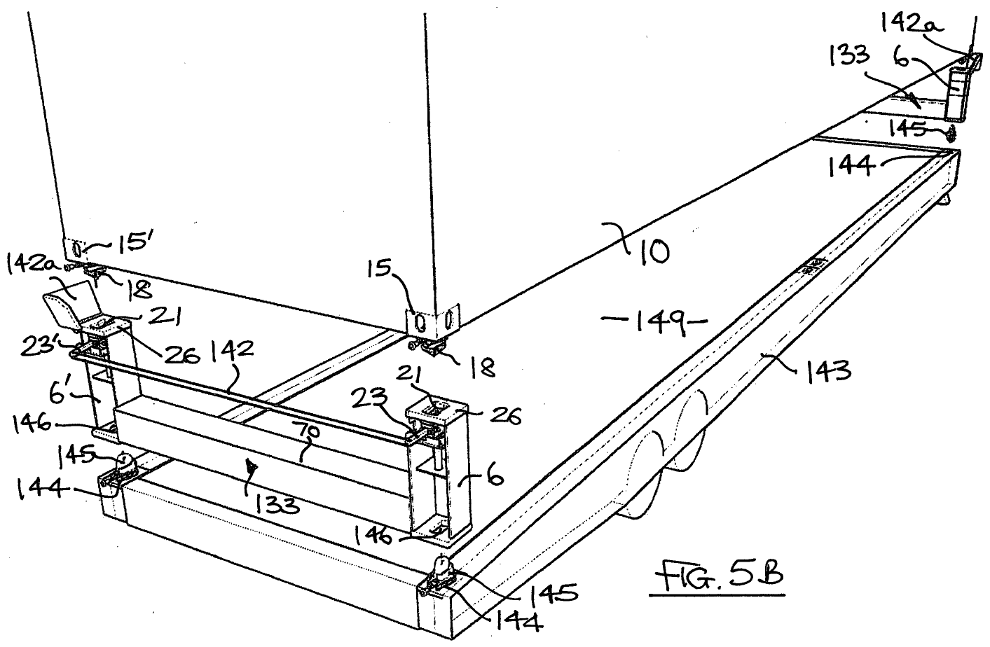

FIG. 5A shows a perspective view of a rig used to proof test a container and its couplers;

FIG. 5B shows a perspective view in more detail of an alternative form of rig for proof testing;

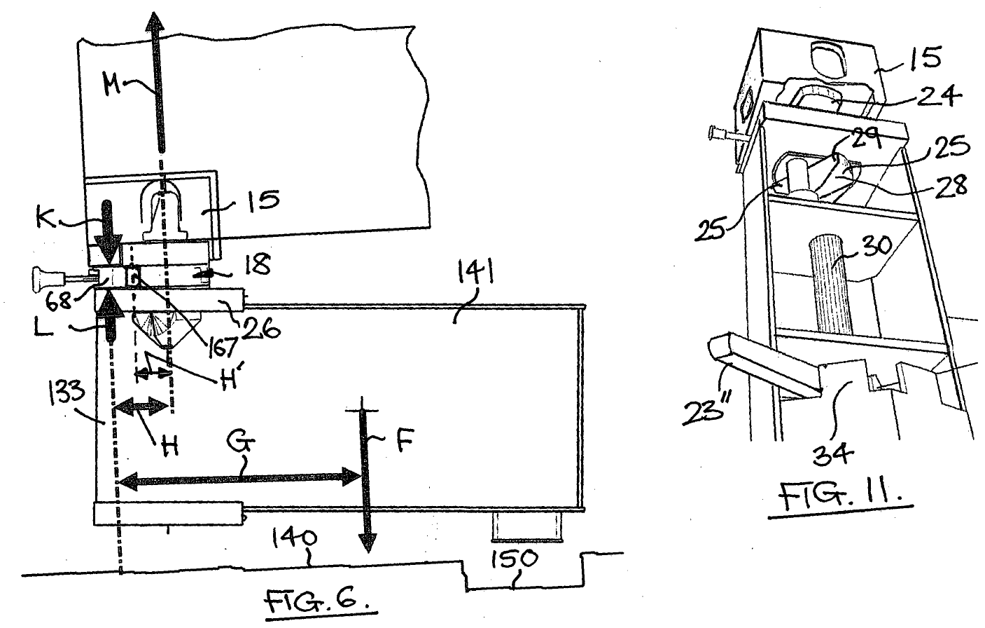

FIG. 6 shows how a container and its couplers can be proof tested simultaneously;

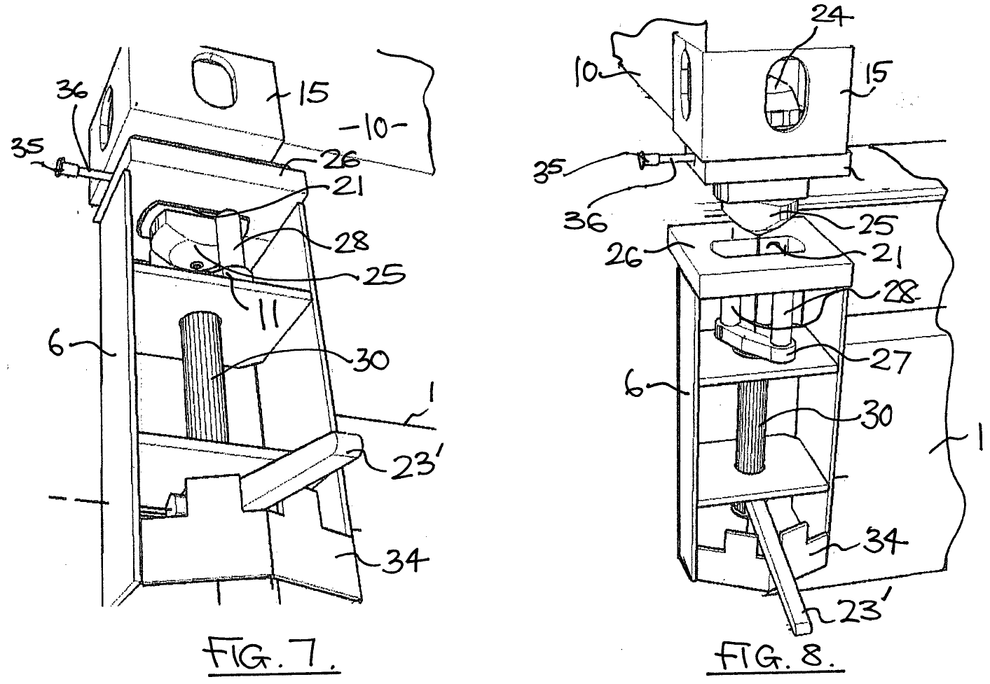

FIGS. 7 to 11 show perspective views at different stages in the operation of a first form of corner unit for use in a proof testing rig and for connecting and disconnecting SATs;

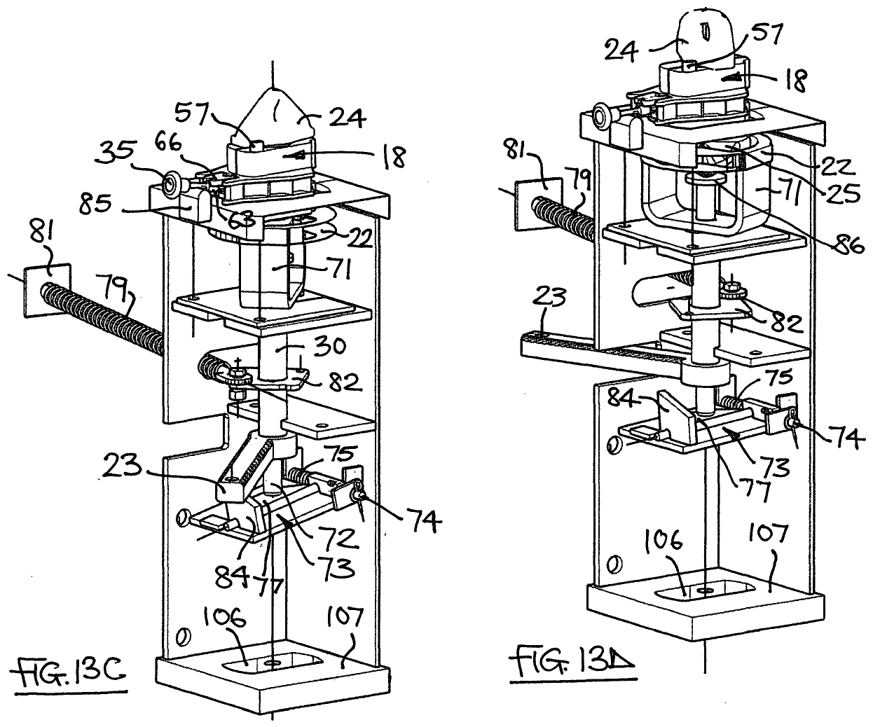

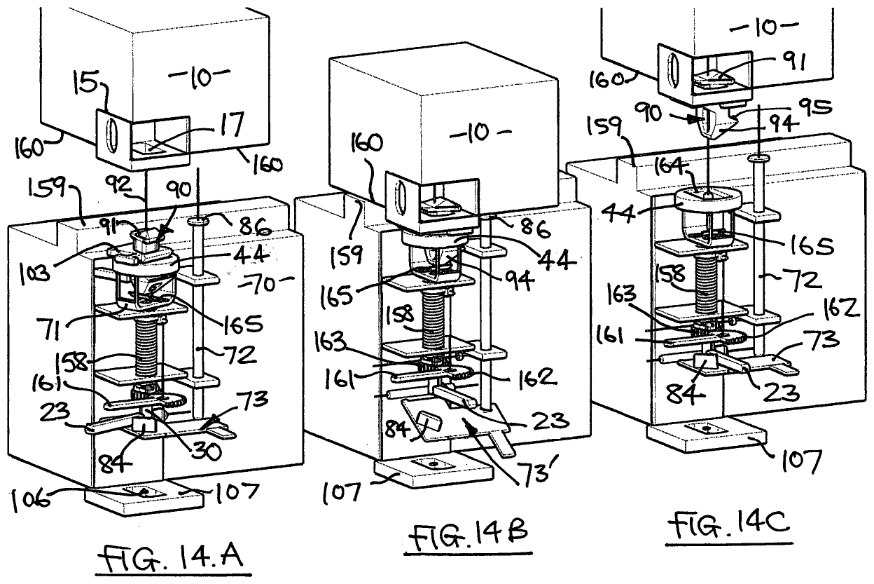

FIGS. 12A to 13D show perspective views at different stages in the operation of a second form of corner unit for use in a proof testing rig and for connecting and disconnecting SATs;

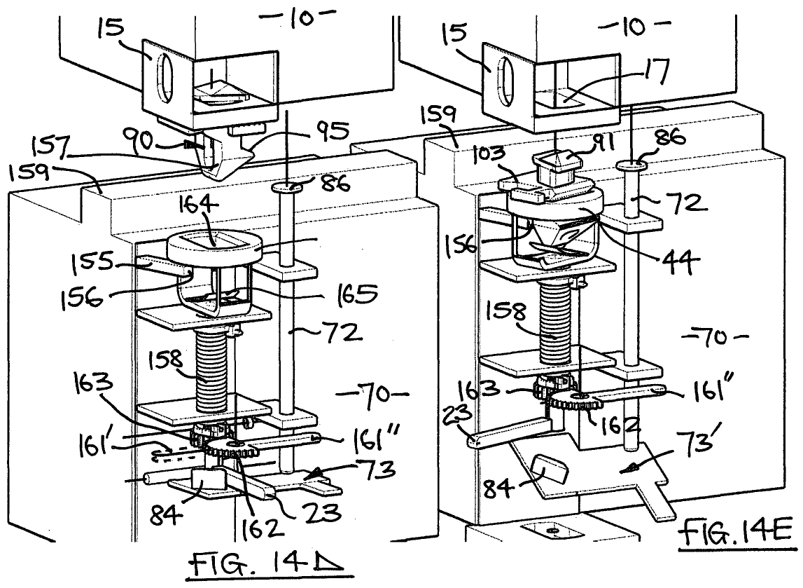

FIGS. 14A to 14E show perspective views at different stages in the operation of a third form of corner unit for connecting and disconnecting fully automatic twistlocks (FATS);

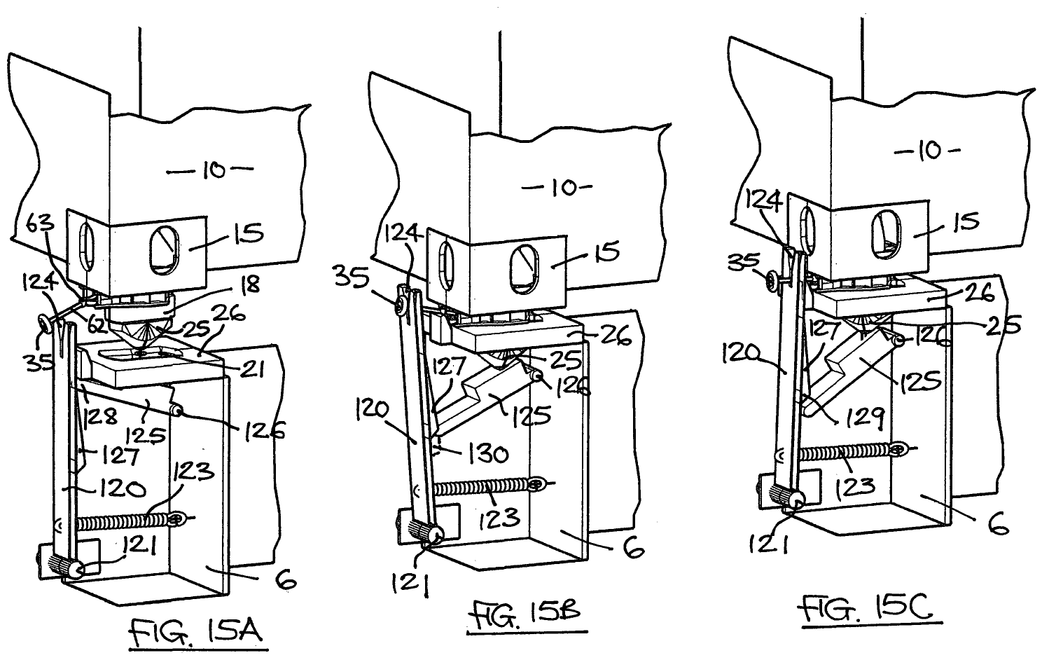

FIGS. 15A to 15C show perspective views at different stages in the operation of a fourth form of corner unit for use in a proof testing rig and for connecting and disconnecting SATs;

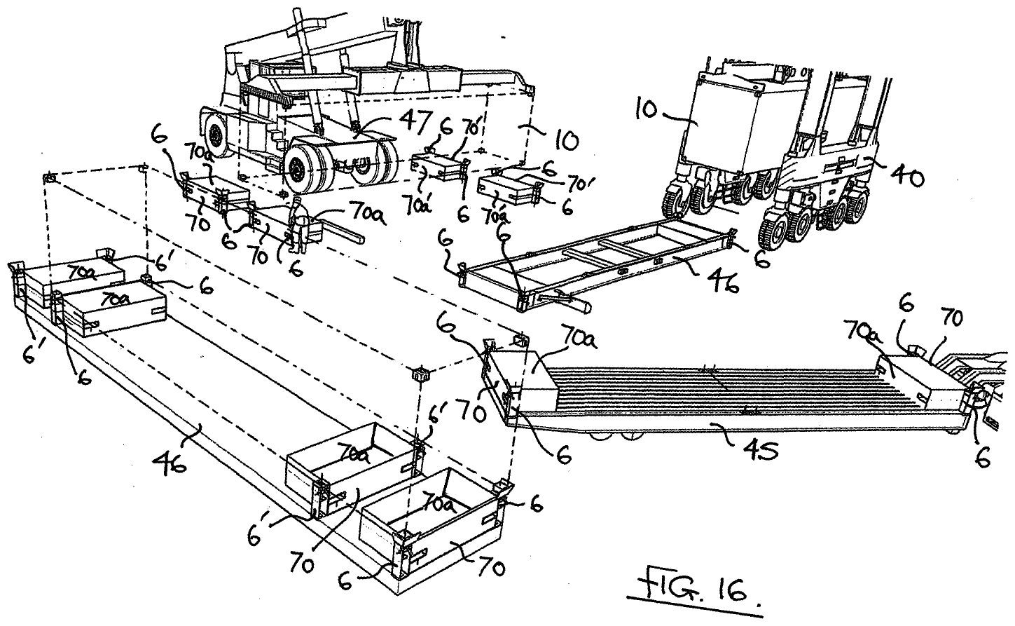

FIG. 16 shows various configurations for rigs in accordance with the present invention;

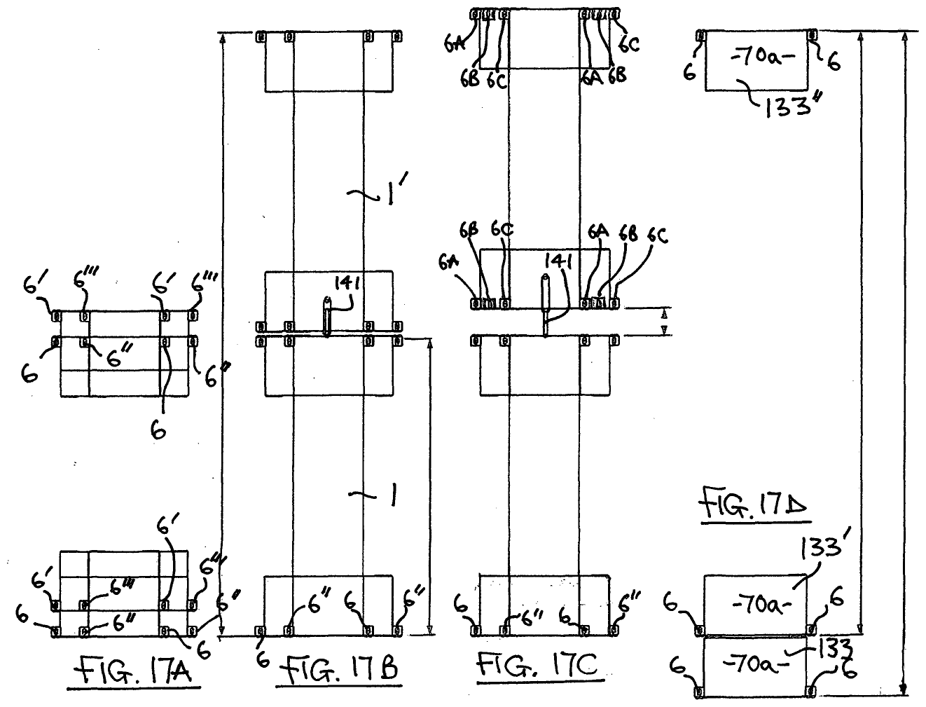

FIGS. 17A to 17D show different rig module layouts for use in the present invention, and

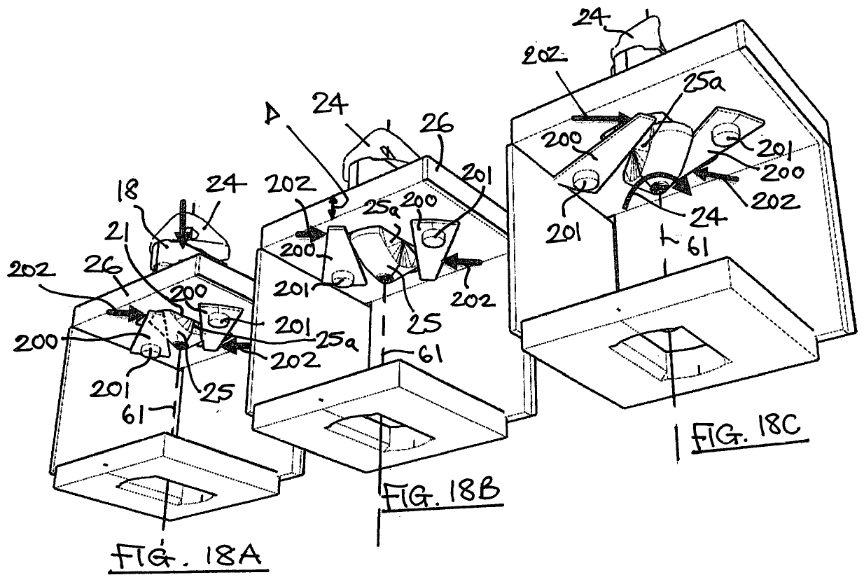

FIGS. 18A to 18C show perspective views at different stages in the operation of a further form of corner unit in accordance with the present invention.

Referring to the drawings in FIG. 1 there is shown a pair of containers in the form of an upper container 10 and a lower container 20 connected by four SATs 18 (semi-automatic twistlocks) connecting the four bottom corner fittings 15 of the upper container 10 to the four top corner fittings 9 of the lower container 20. This pair of containers are being lifted in vertical tandem lift (VTL) by a known container spreader 19 the spreader being connected to the top fittings 9 and the lower container 20 suspended from it. It will be apparent that the spreader 19 is a lifting device, and in this VTL configuration so too is the upper container 10 which is lifting the bottom container 20. The containers 10 and 20 are considered to be empty but if local rules allow lightweight cargos such as automobiles to be transported in VTL such light cargos could be carried.

In FIGS. 2A, 2B, 2C is shown a known type of SAT to provide a better understanding how a typical SAT 18 works. The SAT has a dumbbell shaped lock 58 comprising an elongate conical head 24 connected to a similar shaped tail 25 joined by a vertical shaft 60 which rotate about the axis 61 of the shaft. Shaft can be rotated a wire rope 36 wrapped around the shaft 60 acting against a torsion spring 64 biased to drive the shaft clockwise to the position shown in FIG. 2A. The shaft 60 swivels within bearings formed within an elongate collar 67 formed with intermediate plate 68. FIG. 2C shows part of the collar 67 cut away to reveal the location of the spring 64 and shaft 60.

The positions 2A, 2B, 2C correlate to the diagrammatic section seen in FIGS. 3A, 3B, 3C and 4A, 4B and 4C.

SATs have 3 modes of operation facilitated by rotation about the vertical axis 61 of its head and tail. At the free end of the wire rope 36 is a toggle 35 to allow the operator to pull the wire with his hand. To hold the rotation against the spring 64, there is a ferrule 63 fixed at an intermediate position along the wire which can be engaged with one or more catches holding the head and tail in one of 3 positions 2A, 2B and 2C. In this example it is assumed that the torsion spring is biased in a way to drive the head, shaft and tail assembly in a clockwise direction seen from above. When the toggle wire is pulled out from the body of the SAT the toggle can be pulled out and down to engage the ferrule 63 with a catch 66 or pulled further out and up to catch 65 above it. The degree of rotation varies from one SAT to another. The full rotation of a head and tail is normally within 90 to 110 degrees (say ¼ turn) carried out in two stages of about an ⅛ turn (about 45 degrees) each. The angle of relative orientation of the head and tail seen from above in plan view is about 110 degrees typically. The 3 positions are summarised as
FIG. 2A position with the head locked/tail locked which is used for connecting two containers or other sockets together wherein the head and tail are rotated to project beyond the plan profile of the elongate collar. The ferrule is disengaged with catch 65 and catch 66. Note that the head and tail can be rotated to positions 2B and 2C when the ferrule is disengaged.
FIG. 2B position with the head locked/tail unlocked which is used when a container with connectors is to be unlocked and lifted up from a container or socket below wherein the elongate plan profile of the tail lies within the elongate plan profile of the collar and socket. The toggle is pulled downwards and ferrule is engaged with catch 66. However, if the ferrule were not engaged with the catch, the head and tail could still be held in this position temporarily for example by the index plate. Furthermore, with the ferrule so engaged, the head and tail can be rotated to the position 2C with such as an indexer plate as described below.
FIG. 2C position with the head unlocked/tail locked which is used when releasing a container 10 from engagement with the SAT 18 the elongate plan profile of the head lying within the elongate plan profile of the underside socket of the fitting 15 and the elongate plan profile of the collar yet leaving the tail 25 projecting beyond the collar profile able to be locked within a socket below the SAT. The toggle is pulled upwards and ferrule 63 is engaged with catch 65. Note that in this position with the ferrule engaged, the head and tail cannot be rotated to another position without releasing the ferrule.

When the head and tail are rotated to position 2A driven by spring 64 part of the lock 58 comprising head 24, tail 25 and shaft 60 encounter a stop such as stop 57 which in this example prevent the head from rotating any further and thus keep the head and tail in the important locked position. Likewise when the head and tail are rotated against the spring to position 2C they contact a stop 57 to prevent the head from over rotating out of profile of the aperture through which the head must pass retained thereby the catch 65 and ferrule 63 as described earlier. Stops 57 are known to be located inside or outside the SAT assembly.

Some dimensions of the SATs and related twistlocks are defined by ISO 1161 standards and can be 55.5 mm wide entering into equally defined apertures of width 65 mm spaced apart by a dimension that can vary another 3 mm. The theoretical positional variation of a SAT in an apertures can vary 13 mm but in reality damage, wear and tear and errors in manufacture only serve to increase these figures. The shape of the tails can vary considerably from one IBC or SAT to another and so too the angle of rotation up to the stops 57 can vary. Thus to engage and rotate the tail fully in any direction until the stops 57 are engaged requires acceptance of the variations in geometry and position of the SATs.

Speed is an essential part of port operations and so any mechanism or device than needs energising during container handling and needs time to be energised can cause an unwelcome delay to the processing of the containers. Any sophisticated mechanism is prone to breakdown. So to be certain that a container 10 is the one that is safe to lift another container 20, it needs to be proof tested and reliably so immediately prior to being lifted onto a ship.

In FIG. 5A there is seen a perspective view of one way to carry out the proof testing of a container 10 intended to be used for lifting a second container 20 which is necessary to show that the container 10 is safe to do so. A rig 1 is seen comprising two end modules 133 which each comprise a pair of stub posts or corner units 6 connected by a structure indicated diagrammatically by a member 70 which holds the corner units 6 in the required transverse special relationship to each other so that SATs 18 engaged in units 6 can engage the corner posts 15 of the upper container 10. Container 10 can be lifted by spreader 19 off the support surface by a handling machine such as straddle carrier 40 seen to the right lifting a container 10′ from a container 20′ off another rig 1′. The modules 133 are shown in FIG. 5A as being joined by longitudinal side rails 148 but these side rails are optional and the modules 133 can be held in the correct longitudinal relationship relative to each other by other means such as the twistlocks 145 shown in FIG. 5B. To prevent the straddle carrier driving forward and endangering the manual operator 41 a barrier 39 is provided to block the wheels 43. The barrier can be made as part of the rig 1′ and when it is required that the carrier 40 is driven forward say to the next rig 1, the barrier can be hinged, telescoped or lifted away from the rig manually or by automated means or mechanised and/or operated remotely.

FIG. 5B shows some more detail of the invention. There is a known trailer 143 resting on the ground representing one of several types of compatible equipment for ISO containers such as rail wagons, platforms, other containers, road trailers, ships decks, ground so prepared, jigs, and so on all having known twistlocks 145 either built in or loose in known sockets 144 which are set at the prescribed positions by ISO 1181 to be compatible with series 1 shipping containers so that a container such as container 10 can be lowered onto them and connected through corner fittings 15. In this example, there is seen modules 133 located at each end of the trailer 143. Each module comprises a pair of corner units 6, 6′ connected by a structural beam 70. Since the modules or corner units require locating to mate with the container fittings 15, 15′ in the prescribed positions, and requires a structure to hold them during impact and operation, the corner units 6, 6′ have bottom sockets 146 to engage with twistlocks 145 there to be locked and located securely. Once locked in place the container 10 can be lowered down onto the corner units 6, 6′ and in this part of the operation known SATs 18 hang from the container and prepare to be engaged with sockets 21. Known angled guide plates 142a are envisaged to be fixed to the outer corner and sides of the top plate 26 to guide the container 10 into location and also to protect the indexer and handles which would otherwise be vulnerable to impact. The guide plates 142a are envisaged to be able to be placed in other suitable locations or adjustable particularly in width to allow for containers of different width to be accommodate.

The handles 23, 23′ of corner units 6, 6′ (examples of which are described below with reference to, for example, FIGS. 7 to 11) can be pinned together by a bar 142 so that when loading a container 10 onto the corner units 6 should the container not be level and one catch 84 (shown later) of the corner units 6 be triggered before the other unit 6′, the non-triggered catch in post 6′ would retain the handle 23′ until both fittings 15, 15′ were properly seated on the corner units 6, 6′. The provision of bar 142 connecting handles 23, 23′ enables an operator 41 to operate both handles using a pole 166 or rope acting on bar 142 whilst positioned well clear of any straddle carrier 40 or other lifting machine.

Container 10 is shown being lifted up by the spreader 19. In this embodiment, the rig is weighted with, for example, water tanks or concrete blocks carried in a weight box (not shown) supported from beam 70 of each module 133 to provide a deadweight equal to the lifting proof load required on container 10. This if the proof load be 5 tonnes per fitting 15, then a dead weight of 4×5=20 tonnes gross would be provided for the rig 1. Since the load cannot be exceeded, the container cannot be overloaded and all that is required for the test is that the lifting machine 40 has the capacity to lift such a load. No hydraulics, electronics or other sophistications are needed if a dead weight is used and the simple manually operated corner unit shown in FIGS. 7 to 11 below provides a simple fast system of proof testing. The rig has been fitted with bottom sockets 146 fittings 15′ so that it can be secured to known trailers by their twistlocks and transported or shipped economically. It can also be picked up using a spreader acting through apertures in the top plates 26.

An operating system for use with straddle carriers 40 might have rig 1 of FIG. 5A used to test SATs 18 and container 10 and then carry the container complete with the SATs from rig 1 to be stacked and locked on container 20 on rig 1′ likewise fitted with SATs the whole testing and SAT fitting and VTL assembly taking a matter of minutes to complete with minimal manual intervention which itself could be automated.

The proof test on the container need only be as described perhaps 5 tonnes per corner. However the SAT to be used might be required to be proof tested to a higher load. A SAT can have a typical working load of 25 tonnes. But to lift each corner to provide such a load would exceed the lift capability of a lifting machine and the top container itself. So in FIG. 6 there is seen a means whereby a tensile load of more than the lifting load can be applied to the SAT at the same time as the lifting load is applied to the container.

In FIG. 6 there is seen a side elevation of one lower corner of a container 10 lifted up where fitting 15 is connected to a SAT 18 and thence to corner unit 6 which forms part of module 133 so that when clear of support surface 140 a weight box 141 attached to beam 70 between the end units 6, 6′ of the module tends to hang down at an inclined angle under gravity. The support surface might be that of the structure 149 of a trailer 143 or the ground or a recess 150 in the surface. If as described earlier a 10 tonne load is required per two fittings, or 5 tonnes per single fitting 15 applied by a module then the module weight would need to be 10 tonnes. However if the SAT 18 were desired to be tested at the same time to a vertical proof test load of say 15 tonnes, then FIG. 6 illustrates how this might be done instantly together with the proof test of the container 10. The natural reaction point K of the fitting 15 and point L of module 133 on the intermediate plate 68 of the SAT 18 are assumed balanced so that the moment caused by the weight of the module 133 with centre of gravity acting at arrow F some distance G of say 300 mm is balanced by the moment caused by the vertical tension M of example 5 tonnes in SAT 18 and its moment arm H from the reaction points K, L. If H is of length 100 mm and G of length 300 mm then the tensile force in the SAT 18 will be some 3 times greater than the weight of the module. The fitting 15 will have been at the same time tested for a vertical load of 5 tonnes and sustained a substantial pull out force through the SAT 18 to further enhance proof test. Once tested the container 10 can be connected to a container 20 and locked to it for top lifting in a vertical tandem lift, put on a ship and carried to a far away destination. It is envisaged that the distance H can be adjusted to, for example H′, according to need in several way such as by inserting thin shims at the appropriate positions on either side of the intermediate plate 68 or by inserting spacers 167 between fitting 15 and top plate 26 thus bypassing the intermediate plate 68 yet providing the reaction points K and L.

Other methods of testing are envisaged such as applying vertical downward tensile loads through the bottom fittings 15 of a restrained or supported container 10. The loads can be applied by gravity, hydraulic rams, jacks, and so on and the loads verified by instrumentation in the twistlocks of the lifting spreader or hydraulics or whatever is suitable and known. The method of testing is envisaged to be carried out by this or any other way to prove the container as a lifting device and/or the SATs to go with it.

It will be appreciated that the proof testing is applicable primarily to the top container 10 to be used as the lifting element, and the SATs that are fitted to its four bottom fittings 15. So immediately once proof tested, a recording system and then simultaneously or soon after a data base is created to store the data. It is envisaged that a handheld computer or smart phone be used as a data input device with internet connection to a data server which can be accessed by authorised companies and personnel. The data relating to the container 10 and SATs 18 proof tested is generated including at least some of the following date of test, container number and its known statistics, test load, inspector identification, container and coupler condition and approval. The data so collected and approved by the inspector then forms or generates a formal certificate verifying that the proof test and inspection has been carried out correctly.

Most important is that the receiving port in the far away destination can then check the certificate generated to verify that the two coupled containers 10, 20 can be safely lifted off the ship in vertical tandem lift by the top container 10 through its SATs. Thus the system of proof testing prior to shipping, coupling two containers one on another in VTL, shipping, and discharging of the containers in a safe and efficient manner in VTL has been achieved, and immediately so prior to its shipping.

FIGS. 7 to 11 show a manual locking corner unit 6′ which has a top plate 26 with an aperture 21 to receive the tail of an SAT. Below top plate 26 an indexer 11 is mounted on a shaft 30 supported for rotation in bearings 31. Shaft 30 has a handle 23/lever for rotating the indexer which comprises a plate 27 with two rods 28 projecting upwards therefrom to act on the sides 29 of the tail 25 of the SAT. When the container 10 with fitting 15 comes to rest on top plate 26 the SAT 18 can then be rotated using handle to the position shown in FIG. 2B wherein the head remains locked inside the bottom fitting 15 and the tail 25 is held in the unlocked position by means of indexer 11 and its handle 23 captured in position 23′ in a castellated retainer 34 which holds the handle 23 and its indexer 11 in one or more desired locations.

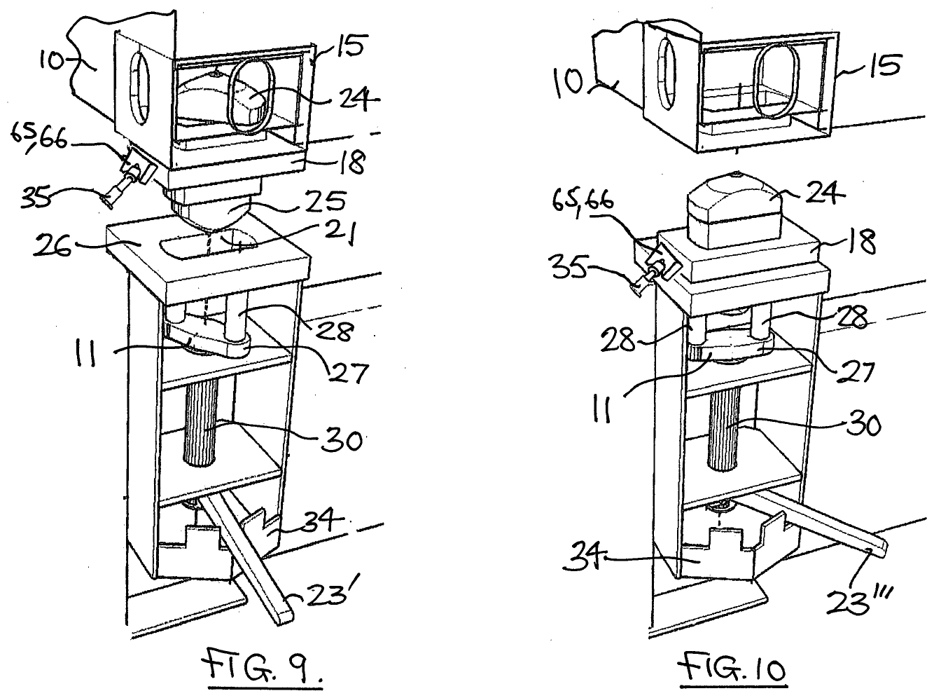

With the tail 25 in the unlocked position, and the head 24 locked inside the fitting 15, the container 10 can now be lifted up and away from the rig 1, as shown in FIG. 8, drawing the SATs 18 out of the aperture 21 with it. Once lifted the tail 25 becomes unrestrained or guided by the indexer 11 and aperture 21 so that the built in SAT spring urges the head and tail of the SAT back to the default position shown in FIG. 2A, the head now becoming fully locked inside the fitting 15 and the tail 25 set in its position 2A for automatic locking into top fittings 9 of another container 20 to form a VTL as shown in FIG. 1, or to be stacked as normal on top of a container on a ship and locked to it.

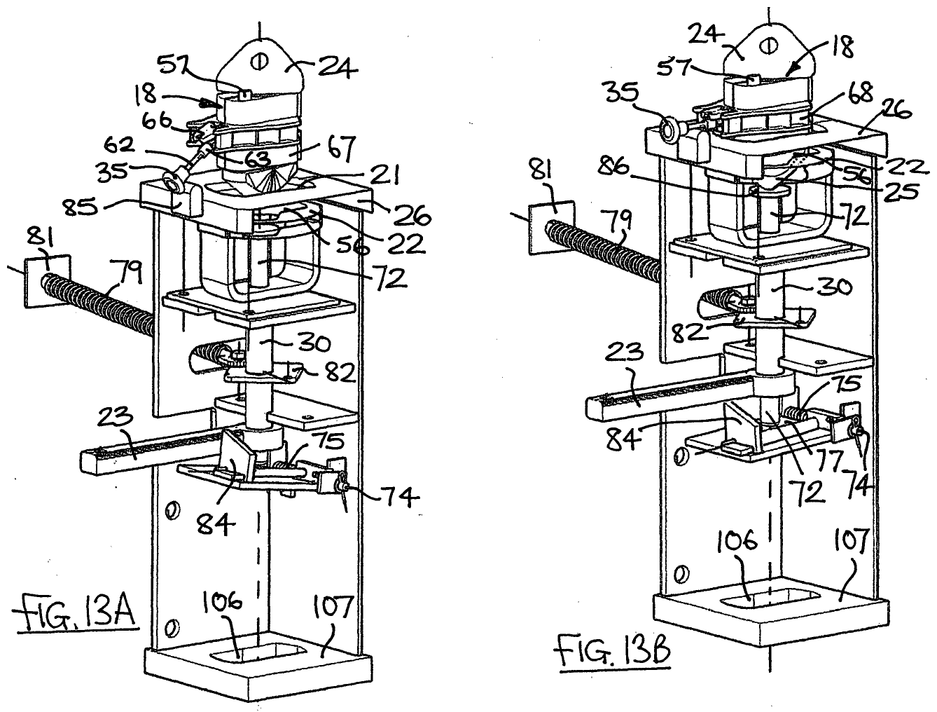

However, when it is required that the SAT is locked to the bottom fitting 15 and plate 26 as described earlier for proof testing, the handle 23 of the indexer 11 is released from the retainer 34 and rotated to position 23″ shown in FIG. 11 in which the coupler is in the FIG. 2A position.

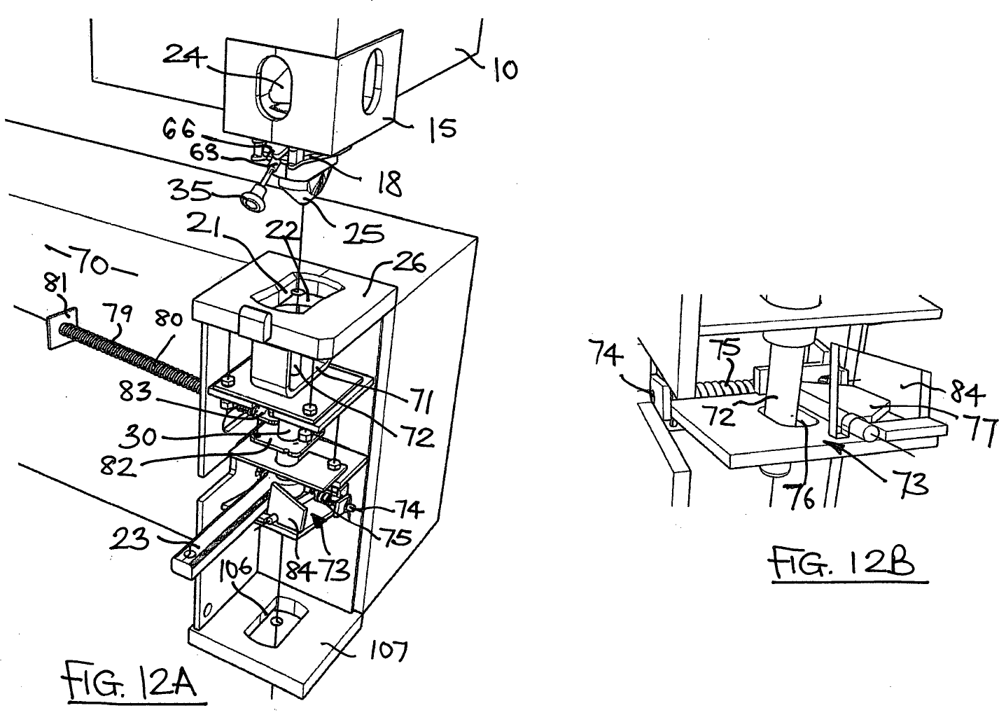

In a return trip when a container 10 or 20 is to have its SATs 18 removed before transporting it on road and rail which might require no SATs to travel with it, the SATs can be removed manually using the same corner units 6, 6′ and indexers as seen in FIGS. 9 and 10. In known operations, when a container is released from a deck or stack of containers on ship, the SATs 18 are set in position 2B with the toggle pulled down and the ferrule 63 secured in catch 66. With the tail open, the container can be lifted off another container taking with it the SAT its head 24 remaining locked inside its bottom fitting 15. The container can then be lowered onto the rig 1 seen in FIG. 9. Once there the indexer 11 can be rotated counter clockwise by moving handle 23 to its 23′″ position as shown in FIG. 10 to drive the tail and head to position 2C. The SAT is now locked inside the stub post 6 and the head 24 unlocked from the fitting 15. The container 10 can thus be lifted off leaving behind the SATs with the stub posts 6. Rotation again of the indexer 11 to the position 2B rotates the head and tail ⅛th turn allowing the tail to be lifted out of the stub post socket 21 and stored in a bin ready for returning to the ship or re-use.

It is envisaged that operation of the handle and removal and fitting of the SATs onto the stub post can be done by robot with the SAT bins being fitted out with racks to orientate the SATs for the robot to pick up and/or store in an orderly manner rather than randomly. The purpose of the handles 23 as illustrated is to provide levers for rotation as described. However it is envisaged that the handles could be located within the body of the corner unit 6 or module 133 and provide levers driven remotely in simple terms by a linkage such as bar 142 and pole 166 or by a prime mover, for example electro-hydraulic motor and actuator, acting on a linkage to a handle/lever in the form of a spigot, gear drive and/or torsion spring as described later, or other mechanical rotator. Similarly the operation of handles/levers 23 described below could also be by a prime mover rather than manual operation.

In an alternative form of corner unit seen in FIG. 12A the container 10 with fitting 15 is being lowered towards a corner unit 6 fixed to a frame 70. A SAT 18 locked to the container corner fitting 15 is seen in the head locked tail open in position 2B with the ferrule 63 locked in catch 66 typical of a container having just been unlocked from a ship and lifted off the ship with a crane. The diagram shows the top plate 26 partly cut away to show an indexer 22 located under the plate 26. The indexer is supported on a bracket 71 welded to a shaft 30 comprising a hollow tube rotated by handle/lever 23. Within the shaft 30 passes a plunger 72 extending from its top adjacent to the socket 21 to below the handle 23 and able to slide up and down inside the shaft 30 prevented from dropping out of the shaft by a catch assembly 73. The catch assembly 73 is mounted pivotally by pin 74 to the corner unit, and about the pin 74 is mounted a torsion spring 75 which urges the catch assembly upwards thus supporting the plunger 72 and catch 84 up adjacent to handle 23. FIG. 12B shows a slot 76 made in the catch assembly through which the plunger 72 can fall when bridge 77 mounted on the catch assembly is flipped over 180 degrees which otherwise supports the lower end of the plunger. In FIG. 12A a compression spring 79 is seen mounted on a shaft 80 within it which can slide through a support 81 fixed to the frame 70. The shaft 80 is pinned at clevis 83 to an arm 82 fixed to the shaft 30 such that when the spring 70 is preloaded and compressed between support 81 and clevis 83 the arm 23 is biased to rotate counter clockwise seen from above driving the shaft, handle and indexer counter clockwise. The rotation is resisted by the handle 23 being stopped by catch 84 mounted in the catch assembly. Note that the natural rotation of the SAT described around FIGS. 2A to 2C is biased by its spring 64 clockwise seen from above. The typical torque of the spring 64 is 600 kg·mm. The torque provided by the spring 79 acting about the arm 82 can be engineered to be whatever is suitable in this example 1200 kg.mm being twice that of the spring 64 able to overcome it and drive the head and tail in the opposite direction counter clockwise.

Further lowering of the container and SAT is seen in FIG. 13A. For clarity the container 10 and fitting 15 are not shown. The SAT 18 starts to enter the socket 21 and the wire 62 or ferrule 63 and/or toggle 35 encounter the guide 85 fixed to the plate 26. In FIG. 13B further lowering of the SAT 18 places the intermediate plate 68 on top of the plate 26, collar 67 through socket 21 and tail 25 through socket into aperture 56 of indexer 22. The guide 85 urges the ferrule 63 to disengage with catch 66 and supports it to remain disengaged from the catch and which would allow the head 24, tail 25 to rotate clockwise freely but for the fact that the tail 25 is captured by the indexer 22 held in place by the action of spring 79 and handle 23 abutting catch 84 allows the open tail 25 to be freely into the socket 21. However as the lowering of the SAT has been taking place, the tail 25 is timed to make contact with the top 86 of the plunger 72 which acts on bridge 77 causing catch assembly 73 to rotate about its pivot 74 and driving catch 84 towards the released position until a point is reached when the handle 23 is free of restraint of the catch 84 (FIG. 13B). If the geometry of the tail 25 is such that it makes contact with the top 86 of the plunger 72 too soon, it is envisaged that the length of the plunger can be adjustable to be made or substituted with a shorter length in this example or longer if the timing is too late.

In FIG. 2A one can see the ferule 63 aligned to move between the known catch 65 and 66 so that the SAT can operate freely with its own torsional springing. The wires 36 can sometimes be distorted or flexible so a guide 85 is provided to ensure that the ferule does not inadvertently get caught in the catches 65, 66 during the fitting operation in which the head is rotated by the fitting 15 and must be allowed to rotate back to the position 2A without restraint by the ferule.

In FIG. 13C the moment has just passed when handle 23 is free to rotate counter clockwise along with shaft 30, arm 82, bracket 71, indexer 22 driven by spring 79 which having more torque than that of the SAT spring 64 drives the lock 58 counter clockwise until in this example the head 24 encounters stop 57 and geometric clearances and gaps and position variations in the siting of the SAT in the stub post and corner fitting 15 are taken up by the driving of the spring 79 until the lock 58 is prevented by more rotation by the stop 57. The head 24 now becomes aligned with the socket in the underside of fitting 15 so that the container 10 is now unlocked from the SAT, the tail 25 is locked to the plate 26, and the container 10 can be lifted away without the SAT 18. With the container lifted away, a man can now safely move forward and rotate the handle 23 clockwise so that plunger 72 acting on the tail of the SAT helps an operator drive the SAT upwards and out of the socket 21 plate 26 for re-use.

In FIG. 13D should it be required to not yet lift the container off the plate 26 but lock the container 10 to the corner unit for proof testing as described earlier, then the handle 23 can be rotated clockwise initially against the action of the spring 79 and arm 82 until the line of action 89′, 89″ of spring 79 (see FIGS. 4B and 4C) goes over centre of the axis 61 of the SAT when spring 79 and now assists the clockwise rotation of the SAT spring 64. If the ferrule 63 is still engaged with the catch 66 it must first be disengaged by hand or other means. Spring 79 acting on the arm 82 now drives the handle 23 and indexer 22 its associated parts until rotation of lock 58 reaches the end of its movement and is stopped by stop 57 with the head and tail of the SAT in the clockwise locked head and tail position 2A. Any geometric clearances between indexer 22 and tail 25 and gaps and position variations in the siting of the SAT in the stub post and corner fitting 15 are taken up by the driving of the spring 79 until prevented by the stop 57 of the SAT. FIGS. 3A, 3B, 3C and 4A, 4B, 4C show diagrammatically in section in plan view the locations of the head and tail of the typical SAT seen from above and it can be seen how the line of action 89 of the spring goes from producing a clockwise moment acting on arm 82 about the axis 61 to 89′ and 89″ producing a counter clockwise moment. One can see how the tail 25 overlaps the socket 21 (seen in dotted line) of plate 26 (seen in dotted line), how in FIGS. 4A to 4C face 57 of socket 56 in indexer 22 is contacted and drives, how space 38 enables tail 25 to rotate freely ⅛ turn counter clockwise during operations.

Once the container and the SAT are removed the corner unit 6 can be set to automatically pick up SATs set upon it by lowering a container 10 without manual or mechanical intervention. To set the post 6 the catch assembly 73 is pushed downwards to rotate about pivot 74 until free of the bottom of the plunger 72. The bridge 77 is then flipped over about 180 degrees to reveal the slot 76. The catch assembly is then allowed to rise up driven by spring 75 and thus holding handle 23 against the action of spring 79, and the plunger drops down through the slot 76 by passing the catch assembly and avoiding contact with tail 25 of an SAT. A SAT can now be placed within the plate 26 without triggering the catch 84 thus keeping the handle and head and tail of the SAT steady and ready to be picked up by the lowering of a container down onto it and lifted off. The guide 85 supports and prevents the ferule 63 getting trapped by catch 66 or 65 which would otherwise prevent the lock 58 rotating to position 2A.

If no bridge 77 is included in the embodiment, then the plunger 72 can be removed such as by lifting it out through the top socket 21 so that the tail 25 of a SAT does not activate the catch 84 and thus the indexer remains in position 2B held by the catch and the handle 23.

In FIGS. 14A, 14B, 14C, 14D, 14E there is seen a sequence of operation of another embodiment of the invention for use with known FATS such as those shown in DE102012201797 and US 20150203287.

In FIG. 14A a container 10 with its fitting 15 with socket 17 is seen being lowered towards the head 91 of a FAT 90. The FAT 90 has tail 94 inserted into socket 164 of indexer 44 similar to indexer 22 seen in FIG. 14D. The socket 164 is of elongate shape similar to socket 17 in fitting 15 so that hook end 95 of FAT 90 engages inside the socket 164 and the intermediate plate 103 is supported close to indexer 44. A leaf spring 165 mounted within bracket 71 is set there to urge the tail 94 of the FAT upwards and unimpededly support it so that the intermediate plate is above the indexer 44 by some 4 to 10 mm. This spring 165 helps the FAT 90 to free itself from the socket 17 and in the case of the FAT claimed in DE102012201797 it is necessary to raise the FAT 90 up to clear its socket plugging shape before it is able to be rotated. It is envisaged that other springs or biased guides can be provided to support and offer up the FAT 90 to the socket 17 yet allow deflection as insertion forces between fitting 15 and indexer 44 come naturally into play.

The position of the indexer 44 with socket 164 is such that head 91 of the FAT 90 is aligned with the socket 17 in the fitting 15 so that as the container 10 is lowered the head enters the socket 17. There is provided a torsion spring 158 wrapped around the shaft 30 and which in this position biases the bracket 71 with indexer and handle 23′ to rotate counter clockwise, prevented in doing so by the handle 23′ bearing on catch 84 being part of catch assembly 73 mounted and operated as described earlier. The spring 158 is fixed to the bracket 71 at one end and a gear box comprising gear 163 and 162 driven by handle 161 fixed by conventional means not shown here to the structure 70 of corner unit 6 at the other.

In FIG. 14B there is seen the base 160 of container 10 coming to rest on the top 159 of the structural member 70 and the fitting 15 making relatively light contact with the intermediate plate 103 of FAT 90 contact being maintained by a spring 165. Top 86 of plunger 72 is at this sequence pressed downwards by the base 160 which causes it to press down on catch assembly 73 to position 73′ thus lowering the catch 84 and releasing the handle 23 in turn allowing the shaft 30, bracket 71, indexer 44 and FAT 90 to rotate typically about 70 degrees counter clockwise thereby locking the head 91 inside socket 17 and fitting 15.

In FIG. 14C the container 10 is seen lifted away from the corner unit 6 taking with it the FAT 90 and allowing the plunger 72 to rise up and likewise catch assembly 73. The hook 95 of FAT 90 slides out of the socket 164 by known means entailing a horizontal transverse displacement of the hook 95 as it rises out of the socket.

In FIG. 14D the back 157 of the FAT 90 is seen opposite the hook 95. In this figure the container 10 has engaged with its fitting 15 a FAT 90 and is seen being lowered towards the corner unit 6. The socket 164 is seen aligned with the tail 94 of the FAT and the socket 17 of the fitting 15. A block 155 with stop 156 is fixed to the structure 70 below the rotating indexer 44. The handle 23 abuts the catch 84 and in this position is being urged to rotate clockwise by spring 158. Spring 158 has had its bias reversed by dint of gear 163 being driven in reverse by gear 162 with handle 161 moving from position 161′ to position 161″. The gear ratio of gear 162 to gear 163 is devised to be preferably 4:1 so that from a ¼ turn of the handle 161 in either direction from a neutral position between 161′ and 161″ a rotational deflection of the torsion spring 158 of 360 degrees can be achieved.

As the base 160 makes contact with top 159 the tail 94 enters the socket 164 and plunger 72 is driven down to release catch 84 allowing the handle 23, shaft 30 and indexer 44 to rotate clockwise rotating the FAT 90 clockwise and aligning its head 91 with the socket 17 in the fitting 15. The back 157 of the FAT is driven around to make contact with or come close to stop 156. Container 10 can now be lifted away from the corner unit without the FAT. Friction and jamming of the FAT in the socket 17 might tend to lift the FAT 90 up with the container 10 so to hold the FAT down within the corner unit 6, hook 95 is held within the socket 164 by the location of stop 156 sufficient to prevent the hook sliding out from within the socket yet enabling the FAT 90 to tilt and move to free itself from contact with socket 17 urged on by the direction and support of spring 165.

In FIGS. 15 another embodiment is illustrated wherein an IBC, in this example a SAT, can be received in the tail open position 2B and locked there with its ferule in the catch, yet have the ferule unlocked automatically and the SAT turned automatically into the fully locked position 2A. FIG. 15A shows a corner unit 6 with an indexer 120 in the form of a lever mounted pivotally at pin 121 to the unit 6. A spring 123 draws the indexer towards the unit 6. At the top of the indexer is a clevis 124 shaped to receive the wire 62 behind toggle 35. A plunger 125 sits below plate 26 connected pivotally at pin 126 to unit 6, there being a follower 128 at its free end. The indexer has fixed to its inner face a cam 127 along which the follower slides.

In operation to lock SATs 18 to the post 6 as might be needed when receiving a container with SATs off a ship and needing to lock the container to a trailer or frame automatically for safe transport, the container is lowered towards the post. The tail 25 of the SAT enters the socket 21 and the projecting toggle 35 and wire 62 is guided into the clevis 124. As the lowering continues the toggle and/or wire come to rest on the guide 85 urging the wire and/or toggle upwards drawing the ferrule 63 out of engagement with catch 66. The tail 25 encounters the plunger 125 as seen in FIG. 15B pressing it downwards and driving the follower to slide down the cam 127 and displacing the indexer outwards from the post 6 which in turn draws the toggle and wire and ferrule out of the SAT thus rotating the head and tail of the SAT to position 2C. However just as it reaches position 2C, the follower is arranged to reach the end 129 of the cam freeing the cam from the follower and allowing the indexer to spring back towards the post and releasing the tension in the wire 62. The SAT now rotates under its own built in spring 64 to position 2A with head and tail locked locking container 10 to unit 6 via plate 26, automatically.

Should it be so required to use the corner unit for removing SATs from containers, the cam 127 can be extended by an extension 130 preferably with a detent recess to hold the follower from slipping and so that the indexer remains held in the outward position and thus the SAT in position 2C where the head 24 of the SAT is in the open position thus enabling the container to be lifted off the SAT leaving it locked to the post 6.

The indexer 120 can be fitted with a foot or hand pedal cantilevered out from the outer face to assist or carry out manual movement of the lever to pull the toggle 35.

To accommodate geometric variations in toggle positions, wire lengths, ferrule positions the indexer may need to be deflected not to geometric needs but by a pre-defined force greater than the highest manual hand force it has been designed for typically 15 kg to 30 kg. So the indexer, cam, extensions and plunger can all be made flexible and/or adjustable or the indexer might be driven by hydraulic or pneumatic rams applying a force limit to the indexer located in place of the spring 123 triggered by an electrical switch detecting plunger displacement.

In an alternative construction (not shown) the indexer 120 and the spring 123 could be incorporated into a single curved shaped spring steel strip with a clevis 124 at one end and which is secured to the unit 6 at its other end. In this arrangement the plunger 125 would act on the inside of the spring strip to bend the strip and thus pull on the toggle 35 to operate the SAT as described above.

It is known that other IBCs have been devised which operate with a toggle 35 and wire 62 (see, for example, the IBC described in the Applicant's own UK patent application No. 1903392.7) and it is envisaged that the toggle operating device described above would be adapted to operate such other IBCs.

In FIG. 16 various layouts of the invention can be seen. To allow for different designs and shapes of FATS and SATs and lengths of containers it is envisaged that different configurations of corner posts might be provided for interchanging with each other without need of large bulky assemblies. Therefore it is a feature of the present invention that a pair of corner units 6 are assembled together on one frame 70 and that two such pairs of corner units are then maintained in the required longitudinal special relationship relative to the corner fittings of the container being worked on to form a rig so that all the corner fittings of the container can be worked on simultaneously. Such a rig may be conveniently connected to a terminal trailer, wagon, deck or purpose built frame by connectors of some sort or indeed further SATs between sockets 106 in base plates 107 shown in FIGS. 12 and 13.

In FIG. 16 a complete bespoke frame 46 is illustrated with corner posts 6 fixed at each corner. Alternatively, corner units 6 can be attached in pairs to frame 70 to form modules as described above and frame 70 may include a box in 70a which weight is placed for proof testing. If proof testing is not required such boxes can be used to store the IBCs. The modules can be located on a terminal trailer 93 and secured to it by IBCs which can be spaced apart along the lengths of the trailer to suit different container lengths such as 20 fts, 40 ft, 45 fts. More than one type of corner unit sets can be put on one trailer or frame 40 so that say with a 40 ft spacing requiring SATs to be processed might be offset from a set of corner units set up for processing FATs on the same trailer or frame. If operating the corner units 6 with reach stackers 47 or forklift trucks requiring access to the side of a container, the stub posts on frames can be placed or secured on the ground with access space made between them. Several frames 70, 70′ could be located side by side for faster processing large numbers of containers and fitted as required with different models of corner units 6 should different types of IBCs need to be processed without involving conversion of the mechanisms within them. When the frames 70 are mounted on a trailer 45 they could be conveniently moved to the quayside or other location or adjusted in location should processing of the container so require it. Alternatively a container 10 can be locked to the posts 6 with the SATs and lifted together with any frames to which they are attached with the spreader 19 of a transport machine such as straddle carrier 40 and rapidly moved to another location. Where more than one model of corner unit 6 and say 6′ is required to enable processing of other types of IBCs, then more than one pair of stub posts 6, 6′ can be added to a frame such as 46 so that a container of a given length can be processed either to one end or to the other depending on its type of IBC fitted.

It is envisaged that a rig 1 might be fitted to a trailer or indeed be fitted with wheels to become a trailer in its own right such that a container being lowered onto it can be locked to that trailer using the means described herein to safely transport it without toppling off.

In FIGS. 17A, 17B, 17C, 17D there are seen in plan view some examples of the versatility of the modules 133. In FIG. 17D a pair of corner units 6 can be seen in the bottom right hand corner of the figure. A module 133 is seen at the bottom, adjacent to it module 133′ displaced say 5 ft from it longitudinally, and a third module 133″ some 45ft away from it so that these 3 modules can be used for containers of length 40 ft, and 45 ft long without further length adjustment.

Other modules 133 shown in FIGS. 17A and 17B and 17C can have different corner posts 6, 6′, 6″, 6′″ fitted to accommodate different IBC couplers. For example, units 6 might be for common SATs and units 6′ might be configured for FATs and units 6″ and 6′″ for yet other types of IBC. In FIG. 17A four types of corner unit 6, 6′, 6″, 6′ are set out for use with a 20 ft container.

In FIGS. 17B and 17C two rigs 1, 1′ comprising modules joined to receive 20 ft long containers are set end to end. 20 ft containers are sometimes joined together with longitudinal locks called mid-locks and to fit and remove these the containers might need to be displaced apart longitudinally. The FIG. 20C illustrates how a hydraulic ram 141 or other mover could be used to displace or bring together the two rigs 1, 1′ to fit or remove mid-locks.

In FIG. 18A, B, C there is seen an alternative embodiment of a corner unit 6 with an alternative resiliently biased indexer. In FIG. 18A the indexer comprises levers 200 which are connected to the underside of top plate 26 at pivots 201 and are driven towards each other by springs denoted by arrows 202 to partially close off the socket 21 in top plate 26. A SAT 18 is being driven downwards into the socket 21 and its tail 25 is restricted by the levers where they overlap the socket as denoted by dotted lines in FIG. 18A. The elongate shape of the tail 25 of SAT 18 is prevented from rotating about its axis 61 by the elongate shape of the socket 21. The sloping faces 25a of the tail 25 press on the levers and urge them to open out against the springs so that, as shown in FIG. 18B, the tail and SAT 18 can now pass downwards through the socket 21. However until the tail 25 has passed completely through the thickness of the top plate and depth of socket dimension ‘D’ typically 28 mm the tail cannot rotate. Only when in the position seen in FIG. 18C where the tail has passed through the socket can the tail rotate counter clockwise as denoted by arrow 204 about axis 61 driven there by the force of the springs denoted by arrows 202 against the clockwise driving force of the built in spring 64 within SAT 18. Now in FIG. 18C the tail 25 is locked under the top plate 26 and the head 25 rotated to the position seen in FIG. 2C in which a fitting 15 can now be lifted off freely off the head 24, and the SAT 18 be retained within the corner unit. To remove the SAT from the corner unit, the tail or head is rotated clockwise against the levers until the tail aligns against the socket.

In order to fit a SAT using such a corner unit a thick plate with an aperture aligned with the socket in the unit is placed on the top plate of the unit so that a SAT can be placed into the unit with the aperture in the thick plate and socket in the top plate holding the tail in the open position. If a container is now lowered onto this SAT the head will automatically be deflected by the container lower socket to the open position against the internal spring loading of the SAT and will then snap back into the head locked position within the socket of the lowered container allowing the container to then be raised with the SAT locked in its the lower fitting socket. The thick plate can conveniently be hinged to the corner unit so it can be flicked on and off the top plate as required when switching between removing and fitting SATs.

It is envisaged that the levers 200 could be made and set up in similar geometry and operation to indexer 22 as described earlier and if applied without the plunger 72 and associated release mechanism yet partially closing off the socket as described above and being driven open by the tail entering the socket and then driven to lock the tail under the top plate once the tail is through the top plate.

To free the tail or to set the SAT 18 in position 2B handles and positional holding means would be added in principle as describer earlier with a means to hold the indexer steady for fitting and lifting off SATs 18 in position 2A.

It is also envisaged that a rig in accordance with the present invention may include more than one pair of corner units at each end of the rig, different pairs of corner units being used for different types of coupler or for carrying out different operations on couplers placed in the corner units. For example, each end of the rig might have three pairs of corner units one pair to attach couplers to containers, one pair to detach couplers from containers and the third pair to lock the container to the rig for proof testing. These couplers can be close together, and even combined into a single three aperture unit. The upper part of FIG. 17C shows diagrammatically units 6A for testing, units 6B for auto fitting and units 6C for auto removal of SATs.

In FIGS. 17, for example, one pair of corner units 6 might be made as the embodiment described in FIG. 18A for removal of SATs 18 and another corner unit 6″ might be made with an indexer 22 best seen in FIG. 4B fixed in position permanently to or temporarily to or formed as part of the top plate 26 for holding the SAT 18 in position 2B for fitting SATs to fittings 15.

It is an important feature of the present invention that the rig provided is quick in operation as the various corner units operate immediately the container is lowered onto the rig with the operation of the corner units being triggered by lowering of the container onto the rig. Thus an operator can place in the rig or remove from the rig couplers whilst the handling machine is picking up its next container giving a more or less continuous process.

A further important feature of the present invention is that the rig provided can be transported to its port of use in sections for assembly at the port.

Although the invention has been described above in relation to rigs used on the dock side or on a trailer it will be understood that the rigs could be used on a ship's deck to remove couplers from containers on board ship or could be used on containers or on structure connected to cranes or other lifting machinery.

1. A method of testing a shipping container having lower corner fittings, the shipping container being tested for use as an upper container during a vertical tandem lift of a lower container, the upper and lower containers in a vertical tandem lift configuration, the method comprising:
supporting the shipping container other than by the lower corner fittings;
connecting couplers in the lower corner fittings of the shipping container; and
applying a proof load on the couplers to test whether the shipping container can sustain forces at least through the lower corner fittings which will be experienced during use of the shipping container as an upper container in a vertical tandem lift of a lower container.

2. The method according to claim 1, wherein applying the proof load comprises:
connecting a test rig to the couplers; and
moving the test rig and shipping container relative to each other.

3. The method according to claim 2, wherein moving the test rig and shipping container comprises lifting the shipping container away from the test rig.

4. The method according to claim 2, wherein moving the test rig and shipping container comprises applying mechanical/hydraulic force between the test rig and the shipping container.

5. The method according to claim 2, wherein moving the test rig and shipping container comprises:
loading the test rig with a test force sufficient to apply the proof load; and
lifting the shipping container via upper corner fittings.

6. The method according to claim 5, wherein the test force is off set from the couplers to apply an additional leveraged load on the couplers more than the value of the test force.

7. The method according to claim 5, wherein the test force is applied as a dead weight.

8. The method according to claim 21, wherein moving the test rig and shipping container comprises:
holding down the test rig; and
lifting, by a machine applying a test force sufficient to apply the proof load, the shipping container via upper corner fittings;
wherein load cells measure the test force on the couplers and the lower corner fittings of the shipping container.

9. The method according to claim 1 further comprising:
recording test data regarding the test; and
storing the test data;
wherein recording and storing the test data is for its future reference and proof of the fitness of the shipping container for use in a vertical tandem lift.

10. The method according to claim 9, wherein the recorded test data includes data selected from the group consisting of data representative of: a date of the test, a shipping container number and its known statistics, a test load, an inspector identification, the proof load, shipping container and condition of one or more couplers, and an approval of the shipping container; and
wherein the test data so collected forms formal verification that the test of the proof load and inspection has been carried out correctly.

11. A rig configured for connecting to or disconnecting from couplers connected in lower corner fittings of a shipping container, the rig comprising:
two pairs of corner units, each pair forming separate end modules comprising a first corner unit and a second corner unit;
a transverse structure extending between the first corner unit and the second corner unit of each end module, the first and second corner units of each end module being held in a transverse spatial relationship for alignment with respective lower corner fittings of the shipping container; and
a longitudinal structure extending between the end modules, the end modules being held in a longitudinal spatial relationship for alignment with respective lower corner fittings of the shipping container;
wherein each corner unit comprises an indexing means for rotating tail portions of any couplers connected in lower corner fittings of the shipping container inserted into the corner units; and
wherein the transverse and longitudinal structures provide for alignment of each of the four corner units with respective lower corner fittings of the shipping container so that all the corner fittings of the shipping container can be worked on simultaneously.

12.-13. (canceled)

14. The rig according to claim 11 further comprising a box for containing a dead weight sufficient to apply the proof load or for storing couplers or housing a prime mover of the rig.

15. The rig according to claim 11, wherein the longitudinal structure comprises a common base member.

16. The rig according to claim 15, wherein the common base member is a trailer having sockets and/or connectors built into its frame to secure the corner units in the longitudinal spatial relationship.

17. (canceled)

18. The rig according to claim 15, wherein the common base member allows different longitudinal spacing of the two end modules to cater for shipping containers of different lengths.

19. The rig according to claim 11 further comprising at least one additional end module at each end of the rig, different end modules being used for different types of couplers, for carrying out different operations on couplers placed in the corner units, or to accommodate shipping containers of different lengths.

20.-25. (canceled)

26. A corner unit configured for releasably coupling a rig and container with a coupler comprising a semi-automatic twistlocks (SATs), the corner unit comprising:
a lever configured for engagement with a portion of the coupler; and
a plunger configured for engagement with the lever;
wherein when a tail of the coupler is lowered into the corner unit, an actuating member of the SAT, which when pulled rotates its head and tail against internal torsional springing, engages an abutment on an end of the lever;
wherein the lever is configured to move against bias by the plunger which is moved by the tail of the coupler or by the container as it is further lowered onto the corner unit;
wherein the plunger is configured to contact the lever to move the lever against the bias and thus pull the actuating member to rotate the head and tail of the coupler to a head unlocked/tail locked position allowing the container to be raised away from the rig and without the coupler.

27.-28. (canceled)

29. A corner unit configured for releasably coupling a rig and container with a coupler comprising a fully automatic twistlock (FAT), the corner unit comprising:
an indexer;
a bias;
a lever; and
a plunger;
wherein the indexer is configured to receive the FAT placed into the corner unit;
wherein the bias is configured to bias the lever against a stop to hold a head of the FAT in a head unlocked position;
wherein as the container is lowered onto the corner unit, the plunger is configured to move the stop to allow the bias to rotate the indexer to rotate and lock the head of the FAT in a corner fitting of the lowered container in a head locked position and to allow the container to be lifted away from the rig and with the coupler.

30. The corner unit as claim 29, wherein the bias is further configured to be reversed so that when the container with the FAT is lowered onto the corner unit, the indexer receives the tail of the FAT in the head locked position; and
wherein as the container is further lowered, the plunger moves the stop to allow the bias to rotate the indexer to rotate the FAT to a head open position to allow the container to be lifted away from the rig and without the coupler.

31. The corner unit according to claim 30, wherein the indexer is further configured to rotate the tail of the FAT towards an abutment thereby restricting space needed by a hook of the FAT to be withdrawn from a socket in the indexer, yet allowing enough space for the FAT to deflect and free the head from the corner fitting of the container.

32. The corner unit according to claim 29, wherein when the FAT is in the head locked position locked in the corner fitting of the container and the tail is engaged with the indexer, the tail is lifted upwards relative to a socket in the corner fitting of the container by a spring to disengage an anti rotation abutment on the head of the FAT to allow the head to rotate in the socket in the corner fitting of the container.

33. A corner unit according to claim 31 further comprising spring biased guides to centralize the FAT within the space into which it can be deflected.

34.-36. (canceled)

37. The rig according to claim 11 further comprising a barrier;
wherein the rig is further configured for use with a wheeled container handling machine; and
wherein the barrier blocks the wheels of the container handling machine to prevent the container handling machine from driving forward and endangering an operator of the rig.
